(19) United States
(12) Patent Application Publication
(10) Pub. No.: US 2008/0110505 A1
(43) Pub. Date: May 15, 2008

(54) Circulating water reservoir tank

(75) Inventor: Eduardo Coronado, San Pedro Garza Garcia (MX)

Correspondence Address: BAKER & MCKENZIE LLP;PATENT DEPARTMENT, 2001 ROSS AVENUE, SUITE 2300, DALLAS, TX, 75201, US

(73) Assignee: COFLEX S.A. DE C.V., Monterrey (MX)

(21) Appl. No.: 11/559,618

(22) Filed: Nov. 14, 2006

(51) Int. Cl. F17D 1/00

(52) U.S. Cl. 137/357

(57) ABSTRACT

Disclosed embodiments describe a water reservoir tank used to temporarily supply a building in the event that the municipal water supply is disrupted. The municipal water supply, the tank, and the building are connected in series, so that any draw of water from the building will cause water in the tank to circulate. As water is drawn from the tank, the municipal water supply will refill the tank so long as the municipal water supply has available water pressure. In the event that the municipal water supply is disrupted, the building may continue to draw water from the reservoir tank temporarily. Once the municipal water supply becomes active again, it refills the tank. The regular circulation of water within the tank provides for a clean, hygienic, and potable back-up water supply for the building.

### FIELD OF THE INVENTION

Disclosed embodiments relate generally to water reservoir tanks, and more specifically to water reservoir tanks that can hygienically serve as a back-up water supply if the municipal water supply is unreliable.

### BACKGROUND OF THE INVENTION

In rural or other areas without a reliable municipal water supply, there may be instances when the water provided to buildings by the municipal water system may be temporarily disconnected. This is often a problem in Latin American countries, for example, in which the municipal water supply may be periodically shut off due to water supply shortages, maintenance and repair issues, rationing, or some other reason. Such an intermittent water supply is often quite inconvenient, as residents (users) may not reliably depend on having water whenever they might need it. To counter this reliability problem, buildings facing such unreliable municipal water service often are constructed with their own water reservoir. The water reservoir may serve as a back-up water supply for the building, temporarily providing water if the municipal water supply is disrupted.

Typically, the water reservoir would be a storage tank connected to the municipal water supply. That way, the reservoir would be filled whenever the municipal supply was operable, and it would provide a source of emergency water whenever the municipal water supply was disconnected. FIG. 1 illustrates such a conventional water reservoir. The water would enter the system from the municipal water line, generally connected via a flow meter. The pipe leading from the flow meter would then branch, with one branch connecting to the building and the other branch connecting to the water reservoir tank. The tank would also have an output line, forming a loop connecting the tank back to the water-in branch from the municipal system. A check valve in the output line would allow water to flow in only one direction through the output line. This check valve would control the flow of water out of the tank based on the pressure provided by the municipal system. So in essence, the water reservoir tank would be connected in parallel with the building it services.

When the water reservoir tank is first connected, the municipal water system would fill the tank (since whenever water is not being drawn for use in the building, it would be available to flow into the tank). Once the tank is full, its fill valve (typically using a float mechanism to indicate a full tank and to close the valve connecting the tank to the water-in branch from the municipal system) would close. Then, so long as the municipal water supply remained active, no water would flow into or out of the water reservoir tank; the building would draw water from the municipal system as needed, and no water would flow into or out of the tank. The water reservoir tank would only become active if the municipal water supply were somehow disrupted.

Whenever the municipal water supply fails to provide water, the water reservoir tank would be available to provide a limited supply of water to the building. As the water pressure from the municipal system drops, the check valve in the output line would open, allowing the building to draw water from the tank. Water would flow from the tank, through the output line, down through the branching pipe, into the building. A second check valve, located between the T-branch (from the tank to the building) and the flow meter (leading to the municipal water line), would prevent the water from the tank from flowing into the municipal system, ensuring that the stored water would be exclusively available for the building serviced by the tank. Typically, as shown in FIG. 1, the tank would be mounted atop the roof of the building it services. That way, whenever the municipal water supply to the building is disrupted, gravity would act to provide water from the water reservoir tank to the building. Obviously, the building would only be able to draw on the limited water supply held by the tank during periods when the municipal supply is disrupted.

Once the municipal water supply has been restored, the building would again draw exclusively on the municipal water supply (rather than the tank), since the check valve in the output line would experience pressure from the municipal water system, closing in order to prevent water stored in the tank from exiting toward the building. Thus, the tank would be refilled by the municipal supply. Again, the tank would fill until the fill valve closed, and it would remain closed (with no water flowing into or out of the tank) so long as the municipal water supply remained on.

While this type of conventional water reservoir does provide a limited, back-up supply of water for times when the municipal water supply is disrupted, it poses another potential problem. Because of its configuration, the water in the tank would sit motionless during any period of time when the municipal water system is operable. The water in the tank would only circulate if the water supply were disrupted and then reconnected. While this may not be a problem if the municipal water supply is regularly disrupted (providing for periodic circulation of water in the tank), hygiene concerns may arise if the municipal water supply is fairly reliable (only being disrupted infrequently). In such instances, the water in the tank may sit stagnant for months or even years. The water in such conventional water reservoir tanks may thus become unhealthy and unhygienic. Any chlorine in the water may become diluted over time, and the stagnant water may become a breeding ground for algae, bacteria, or other potentially harmful organisms. Then if the municipal water supply is ever disrupted, the building would be drawing on unsafe, non-potable water.

Such stagnant water in a water reservoir tank may be a health concern. Certainly, it limits the utility of the water reservoir tank. In fact, this problem may negate the entire point of having a water reservoir, since the reservoir might not serve as a ready source of potable water for emergency situations when the municipal water supply is temporarily disrupted. Thus, an improved water reservoir tank, which prevents stagnant water buildup over time, would offer a substantial improvement in the health and hygiene of the short-term, emergency water supply.

### SUMMARY OF THE INVENTION

Disclosed embodiments provide for regular circulation of the water within the water reservoir tank. The flow of water into the building (from the municipal water supply) is reconfigured to prevent water in the tank from becoming stagnant and unhealthy. Generally, the disclosed embodiments connect the water reservoir tank and the building it serves in series with the water main line from the municipal water supply, so that water from the municipal water supply flows into and through the water reservoir tank, before flowing from the tank into the building. Such a configuration ensures that the water within the reservoir tank is constantly circulating, since the building draws its water from the tank, and the tank is then refilled by the municipal water supply. So the actual usage of water in the building provides for regular circulation and exchange of water within the tank, preventing stagnation and unhealthy buildup of algae, bacteria, and/or other potentially harmful organisms, toxins, or impurities.

### BRIEF DESCRIPTION OF THE DRAWINGS

Embodiments are illustrated in exemplary figures, described generally below:

FIG. 1 is an exemplary diagram of a conventional water tank connected in parallel with a building; and

FIG. 2 is a diagram of an exemplary embodiment of a water reservoir tank connected in series to provide for circulation.

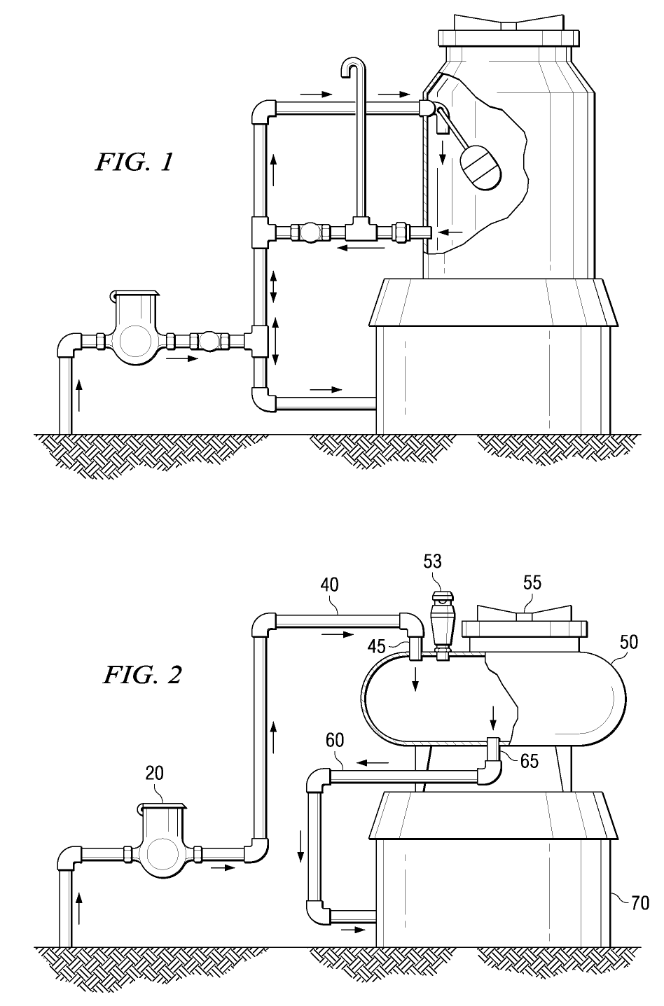

### DETAILED DESCRIPTION OF EMBODIMENTS

Disclosed embodiments seek to provide a hygienic and healthy back-up water supply for use whenever the municipal water supply is disrupted. Generally, this is accomplished by connecting the water reservoir tank in series with the municipal water supply (line-in) and the building to be supplied. Such a configuration allows for regular circulation of the water in the tank simply due to the water usage of the building. Any use of water in the building draws from the tank. The water tank is kept full (so long as the municipal water supply is active), since any draw of water from the tank to the building would have an accompanying introduction of water into the tank from the municipal water supply input line (so long as the municipal water supply is active). Thus, water from the municipal supply flows into the building through the reservoir tank. Accordingly, the water in the reservoir tank is kept clean, with a reduction in the required maintenance and cleaning of the tank, merely by utilizing a configuration that ensures circulation and exchange of water within the tank on a periodic basis.

An illustrative example of such an embodiment of the present invention is shown in FIG. 2. In the embodiment shown in FIG. 2, the municipal water supply is made available to the building 70 through the flow meter 20. The flow meter connects the municipal water supply in series to both the water reservoir tank 50 and the building 70 (and typically serves to record the amount of water that the building draws from the municipal water system for billing purposes). From the flow meter 20, the input water line 40 (which may also be termed a pipe, tube, conduit, etc.) connects to the water reservoir tank 50. In the embodiment shown in FIG. 2, there is no other branch that might intersect the input line 40; the entire flow of water from the municipal water supply to the building flows into and through the tank 50.

The input water line 40 from the flow meter 20 connects to the tank 50 at nozzle 45. In the embodiment of FIG. 2, no valve is needed to prevent backflow from the tank 50 back towards the municipal water system via line 40, since the nozzle is located atop the tank 50. Such nozzle placement allows gravity to prevent backflow (while also ensuring that the tank remains fully filled). As a general rule, the nozzle 45 would be located in proximity to the top of the tank 50, so that the tank's full volume may be effectively utilized to store water. And while the embodiment of FIG. 2 does not use a valve in conjunction with the nozzle, a valve could alternatively control water flow into the tank 50 via the nozzle 45. Such a valve might be useful in allowing the flow of water into the tank 50 to be stopped, providing easy removal or repair of the tank.

In the embodiment of FIG. 2, the tank 50 has an air admittance and release valve 53. While two independent valves could be used for these purposes, the embodiment of FIG. 2 employs a single air admittance and release valve 53 combining these two functions. The air release function of valve 53 serves to vent any air that enters the tank 50, allowing the tank 50 to fill completely with water and preventing air from entering the pipes into the building 70 (in which case, water might exit the faucets in the building along with the water, causing a less controlled stream of water). The air admittance function of valve 53 may be useful in providing for a steady flow of water out of the tank whenever municipal service is interrupted. The valve would allow air to fill the tank 50 as the building 70 draws down the water in the tank 50, preventing the formation of a vacuum in the tank 50 that might hinder the flow of water. While the reservoir tank 50 may function without an air admittance and release valve 53, such a valve (or valves) may improve its performance significantly. The embodiment of FIG. 2 also has an optional cleaning/maintenance hatch 55 on the tank, providing access to the inside of the tank as necessary.

The tank 50 connects to the building 70 via one or more output water lines 60. In the embodiment of FIG. 2, the output water line 60 connects to the bottom of tank 60 at drain 65. This placement of drain 65 in proximity to the bottom of the tank 50 allows gravity to serve as an additional driving force for the water (in case the municipal water system is not providing water pressure), while also allowing the building 70 to draw all of the water stored in the water reservoir tank 50. So whenever water is needed in the building 70 (as for example, when a water faucet is turned on), water would flow from the tank 50 into the building 70 via output line 60.

The municipal water supply acts to fill the tank 50, providing a water reservoir (within the tank) in case the municipal supply becomes disrupted. Whenever water is needed by the building 70, the water would be drawn from the tank 50. In those instances when the municipal water supply is active (such that it has available water pressure), the reservoir tank 50 would simultaneously be filled by the municipal water supply (via the input line 40 connecting the tank to the municipal water supply) as the building 70 draws water from the reservoir tank 50. In this way, the emergency supply of water stored in the reservoir tank 50 would constantly be maximized, and the water within the tank would be kept potable and hygienic due to constant circulation (movement) and exchange (as water drawn out of the tank 50 is replaced by new water flowing into the tank 50 from the municipal water supply).

In those instances when the municipal water supply has been disrupted, however, the reservoir tank 50 would not be simultaneously refilled as water is drawn for use in the building 70. In those instances, the building 70 would draw water from the reservoir tank 50 until the emergency supply stored in the tank 50 has been exhausted. This would provide a temporary supply of potable water for use during any temporary disruptions to the municipal water supply. Once the municipal water supply has been reactivated, the tank 50 would be refilled automatically by the municipal water supply.

In the exemplary embodiment shown in FIG. 2, the reservoir tank 50 is located atop the roof of the building it services, since this allows gravity to provide some water pressure for driving water from the tank 50 to the building 70 any time when the municipal water supply is disrupted (such that there is no water pressure provided by the municipal system). Instead of placing the reservoir tank 50 at a height (elevation) that provides for gravity feeding of water into the building 70, a pump could alternatively be used to provide water pressure for driving water from the reservoir tank 50 to the building 70. While a pump could be used in all instances, typically the embodiment of FIG. 2 would only use such a pumping force when the municipal water supply is interrupted; otherwise, the municipal water supply may provide sufficient pressure itself to drive the water from the tank 50 to the building 70 regardless of tank elevation. Such an alternate configuration using an optional pump would allow positioning of the tank 50 regardless of height, and the tank could be located underground below the building 70, for example. A check/ball/control valve might also be alternatively used between the flow meter 20 and the nozzle 45. Such a valve might be particularly useful if, for example, the nozzle 45 is not located atop the tank 50, as it would prevent any backflow from the tank to the municipal water system.

The disclosed embodiments provide for a series configuration, with the municipal water input line 40, the reservoir tank 50, and the building 70 all connected in series so that water flows along a single path from the municipal water supply system, through the tank 50, and into the building 70. The building 70 draws water from the tank 50 regardless of whether there is a disruption in the municipal water system, and the municipal water supply system simultaneously refills the tank 50 so long as the water supply is active, thus ensuring circulation and exchange of water in the tank 50 on a regular basis. In this way, the reservoir water storage tank 50 may be kept full of potable water for use whenever there is a disruption to the regular water supply from the municipal system. Regardless of the amount of time between disruptions to the municipal water supply, the water in the reservoir tank will be regularly circulated so that it remains hygienic. Thus, the disclosed embodiments may provide a ready source of potable water for temporary use during any disruption to the municipal water supply.

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of the Invention,” the claims should not be limited by the language chosen under this heading to describe the so-called field. Further, a description of a technology in the “Background of the Invention” is not to be construed as an admission that certain technology is prior art to any invention(s) in this disclosure. Neither is the “Brief Summary of the Invention” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What we claim is:

1. A device for providing a building with a temporary source of water when a municipal water supply is disrupted, comprising:
a tank;
an input line operable to connect the tank to the municipal water supply; and
an output line operable to connect the tank to the building;
wherein the tank is connected in series with the municipal water supply and the building, such that water flows from the municipal water supply into the tank, and water flows from the tank into the building.

2. A device as in claim 1, wherein the input line and the output line are separate and do not intersect.

3. A device as in claim 1, wherein any use of water in the building draws from the tank, and the municipal water supply refills the tank so long as the municipal water supply has available water pressure.

4. A device as in claim 1, wherein water from the municipal water supply must flow through the tank before entering the building.

5. A device as in claim 1, wherein the tank further comprises an air release valve.

6. A device as in claim 1, wherein the tank further comprises an air admittance valve.

7. A device as in claim 1, wherein the tank further comprises an air admittance and release valve.

8. A device as in claim 7, wherein the tank further comprises a hatch.

9. A device as in claim 1, wherein the tank is elevated so that water may be gravity-fed from the tank into the building if the municipal water supply is disrupted.

10. A device as in claim 1 further comprising a pump, wherein the pump transports water from the tank to the building.

11. A device as in claim 10, wherein the pump activates whenever the municipal water supply is disrupted.

12. A device as in claim 1, wherein the input line connects to the tank in proximity to the top of the tank, while the output line connects to the tank in proximity to the bottom of the tank.

13. A device comprising:
a water reservoir tank;
an input nozzle operable to connect the tank to a municipal water supply;
an output drain operable to connect the tank to a building;
wherein the tank is connected in series with the municipal water supply and the building, such that water flows from the municipal water supply into the tank, and water flows from the tank to the building.

14. A device as in claim 13, wherein the nozzle is located in proximity to the top of the tank and the drain is located in proximity to the bottom of the tank.

15. A device as in claim 13, wherein water in the tank circulates whenever water is used in the building.

16. A device as in claim 13, wherein any use of water in the building draws from the tank, and the municipal water supply simultaneously refills the tank so long as the municipal water supply has available water pressure.

17. A device as in claim 16, wherein the tank further comprises an air admittance and release valve.

18. A device as in claim 16 further comprising a pump, wherein the pump transports water from the tank into the building.

19. A device as in claim 16, wherein the tank is elevated so that water may be gravity-fed from the tank into the building if the municipal water supply is disrupted.

20. A device as in claim 19, wherein the tank is located atop the roof of the building.

21. A device comprising:
a water reservoir tank;
an input line connecting the tank to a municipal water supply; and
an output line connecting the tank to a building;
wherein the input line and the output line are separate and do not intersect.

22. A device as in claim 21, wherein water circulates in the tank whenever water is used in the building.

23. A device as in claim 21, wherein water must flow through the tank before entering the building.

24. A device as in claim 21, wherein:
the building does not directly draw its water from the municipal water supply, but instead draws water from the tank; and
the municipal water supply simultaneously refills the tank so long as water pressure is available.

25. A method for supplying water to a building, comprising:
connecting the building and a water reservoir tank in series to a municipal water supply system.

26. A method as in claim 25 further comprising:
releasing air introduced into the reservoir tank by the municipal water supply system; and
admitting air into the reservoir tank in the event that the municipal water supply is disrupted.

27. A method as in claim 25 further comprising drawing water from the reservoir tank for use in the building;
wherein the reservoir tank is continuously refilled by the municipal water supply system so long as the municipal water supply system has available water pressure.

28. A method as in claim 25 further comprising regularly circulating water in the reservoir tank to ensure a hygienic back-up supply of water in the reservoir tank for use in the building in the event that the municipal water supply is disrupted.

29. A method as in claim 28, wherein circulation of water in the reservoir tank occurs when the building draws water from the tank.

30. A method as in claim 25, wherein:
water from the municipal water supply system is directed through the reservoir tank to the building;
the building draws water exclusively from the reservoir tank; and
the reservoir tank is filled with water by the municipal water supply system.

31. A method as in claim 25 further comprising:
drawing water for use in the building exclusively from the reservoir tank; and
filling the reservoir tank from the municipal water supply system so long as the municipal water supply system has available water pressure.

32. A method as in claim 31, wherein the reservoir tank serves as a back-up water supply for the building in the event that the municipal water supply is disrupted, and the water in the reservoir tank circulates regularly to ensure a hygienic supply of water in the reservoir tank.

33. A method as in claim 31, further comprising regularly circulating water in the reservoir tank to ensure a hygienic back-up supply of water in the reservoir tank for use in the building in the event that the municipal water supply is disrupted.

34. A method as in claim 33, wherein circulation of water in the reservoir tank occurs when the building draws water from the tank.

35. A method as in claim 33 further comprising:
releasing air introduced into the reservoir tank by the municipal water supply system; and
admitting air into the reservoir tank in the event that the municipal water supply is disrupted.
